(19) United States
(12) Patent Application Publication
(10) Pub. No.: US 2026/0222424 A1
(43) Pub. Date: Jul. 30, 2026

(54) PASSWORD AND EMAIL ATTACHMENT LINKAGE FOR THREAT ANALYSIS

(71) Applicant: Cisco Technology, Inc., San Jose, CA (US)

(72) Inventors: Suresh Gopathy, Alpharetta, GA (US); Gajendar Pandey, Delhi (IN)

(21) Appl. No.: 19/041,883

(22) Filed: Jan. 30, 2025

(51) Int. Cl. H04L 9/40; H04L 51/08

(52) U.S. Cl. CPC H04L 63/1416; H04L 51/08

(57) ABSTRACT

This disclosure describes techniques for password linkage to assist with threat detection related to communications across a network. The techniques include receiving a password-protected email attachment. The techniques include storing the password-protected attachment in a password linkage database in association with first metadata from the corresponding email. The techniques may also include detecting a password in a second email that includes second metadata. Responsive to detecting the password, the techniques include automatically creating a linkage between the password-protected attachment and the password. The linkage may be based at least in part on the first metadata and the second metadata. The linkage may allow a security system to investigate the password-protected attachment for a potential threat. As such, password linkage techniques may improve security in network communications.

### TECHNICAL FIELD

The present disclosure relates generally to threat detection in network communications, thereby improving security of a network against potential threats.

### BACKGROUND

In network environments, users may communicate information across the network. The information may originate from a computing device outside a secure network, system, or organization. For instance, a user within an organization may receive a communication, such as an email, from an outside contact or entity. The email may include an attachment (e.g., document, file, image, data). In some examples, the attachment may be encoded and/or require a password to open (e.g., password-protected). The associated password to open the attachment may be provided separate from the email that includes the attachment, such as in a separate email, or may be known to the user by other means. In a situation where a password-protected attachment is included in an email, but the same email does not also include the password, it may be difficult for a security system of the organization to determine whether the attachment poses a threat to the organization. The security system may need to quarantine communications with attachments until the issue is resolved, potentially leading to inefficiency in communications, lost emails, or consuming administrative resources to analyze problematic communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIGS. 1A-1C illustrate component diagrams with example environments in which password linkage concepts may be employed as part of communications between network devices, in accordance with the present concepts.

FIGS. 2 and 3 illustrate flow diagrams of example methods for the use of password linkage concepts as a part of communications among network devices, in accordance with the present concepts.

FIG. 4 illustrates a computing system diagram illustrating a configuration for a data center that can be utilized to implement aspects of the technologies disclosed herein.

FIG. 5 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes, at least in part, a method that may be implemented by a security system in a networked computing environment that is communicatively coupled to one or more external devices and/or other computing devices. The method may include receiving multiple email communications from the one or more external devices. The method may include detecting an attachment to a first email communication of the multiple email communications and determining that the attachment is password-protected. In some examples, the method may include storing, in a password linkage database, the attachment and first metadata that are associated with the first email communication. The method may further include detecting a password in a second email communication of the multiple email communications. The password may also be stored, in the password linkage database, along with second metadata that are associated with the second email communication. Based at least in part on the first metadata and the second metadata, the method may include automatically creating a linkage between the attachment from the first email communication and the password from the second email communication. In response to the linkage, the method may include using the password to unlock the attachment. The method may also include making a determination whether the attachment poses a security threat. Based at least in part on the determination, the method may include forwarding the first email communication to an intended recipient.

This disclosure also describes, at least in part, another method that may be implemented by a security system in a networked computing environment that is communicatively coupled to one or more external devices and/or other computing devices. The method may include receiving a password-protected attachment that was attached to a first email communicated from an external device. The method may include storing the password-protected attachment in a password linkage database in association with first metadata from the first email. The method may also include detecting a password in a second email that includes second metadata. Responsive to detecting the password, the method may include automatically creating a linkage between the password-protected attachment and the password based at least in part on the first metadata and the second metadata. Based at least in part on the linkage, the method may further include forwarding the first email to an intended recipient at a separate computing device.

Additionally, the techniques described herein may be performed by a system and/or device having non-transitory computer-readable media storing computer-executable instructions that, when executed by one or more processors, performs the method described above.

### Example Embodiments

This disclosure describes techniques for password linkage to assist with threat detection related to communications. An organization may wish to examine an incoming communication to determine whether the communication poses a threat to the organization. For example, the organization may receive an incoming email, and the email may have an attachment. The attachment may be password-protected. The password may not be readily linked to the attachment. For instance, the password may not be conveniently contained within the body of the same email that includes the attachment. However, the password may be provided in a separate email, either before or after the email with the attachment arrived at the organization. In order to streamline communications, it may be advantageous to automatically link a password-protected attachment to its associated password. Once the password-protected attachment and the password are linked, a security system of the organization may be able to analyze the attachment to determine whether the email and/or attachment pose a security risk to the organization.

In secure communication environments, sensitive information may be contained in a document that may be sent as an email attachment, with password protection fixed on the document. The associated or corresponding password to the password-protected document may be delivered in a separate email to enhance security. For instance, if a third party was able to intercept the email with the attachment and the same email also contained the password, the third party may easily gain access to the sensitive information in the document. Therefore, the password is often delivered via a separate communication. However, security systems, such as Secure Email Gateway (SEG) or Secure Mailbox (SM) solutions, may be unable to link passwords that are sent in separate communications with the corresponding documents. Not being able to link the password to the corresponding document can hinder the ability of the security system to scan the attachment for a threat. For this reason, many malicious email (e.g., phishing, Business Email Compromise (BEC), malware) attacks go unscanned.

This disclosure describes techniques for detecting password-protected attachments and passwords. Information regarding both the password-protected attachments and the passwords may be organized and/or stored by the security system. With sufficient organization of the data, the security system may be able to match a password-protected attachment with a password even where these components arrive at different times and via different communications. The security system may attempt to link a password with a password-protected attachment based on metadata or other information associated with the password and/or the password-protected attachment. If a potential link is found, the security system may then use the password to try to test, open, and/or scan the password-protected attachment to detect potential threats. The detection and linkage of the password-protected attachments and passwords may occur automatically and relatively quickly, resolving email security issues in a relatively short amount of time, thereby allowing network communications to proceed efficiently and securely.

To summarize, a more efficient technique is presented for protecting organizations from potentially harmful communications, including email attachments. In some examples, password linkage may be viewed as a way to improve network communications and security, featuring a relatively low computational cost. This solution could help protect users of a wide variety of communications systems.

Although the examples described herein may refer to a security system and/or password detection and linkage service which may be offered via computing resources in a data center, the techniques can generally be applied to any device in a network. For instance, the password linkage concepts are expected to work within any of a variety of email applications, communications systems, messaging systems, etc. Further, the techniques are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

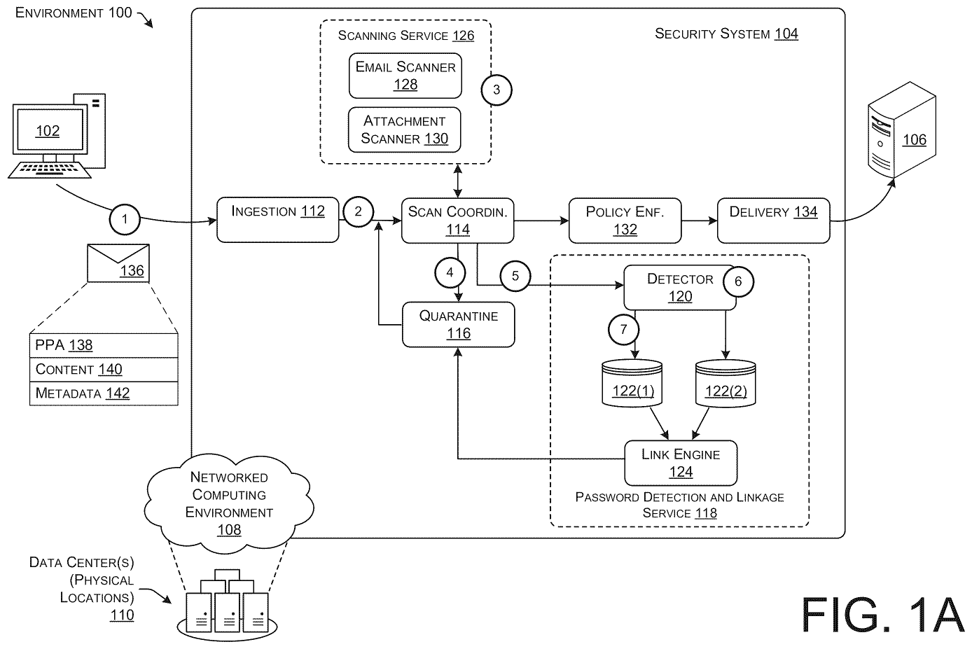

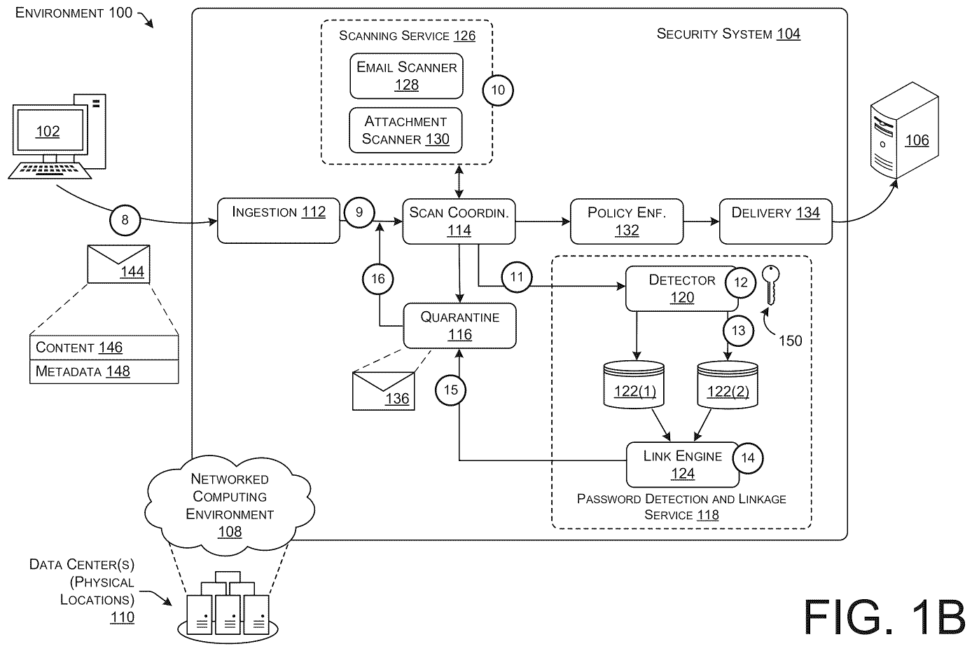

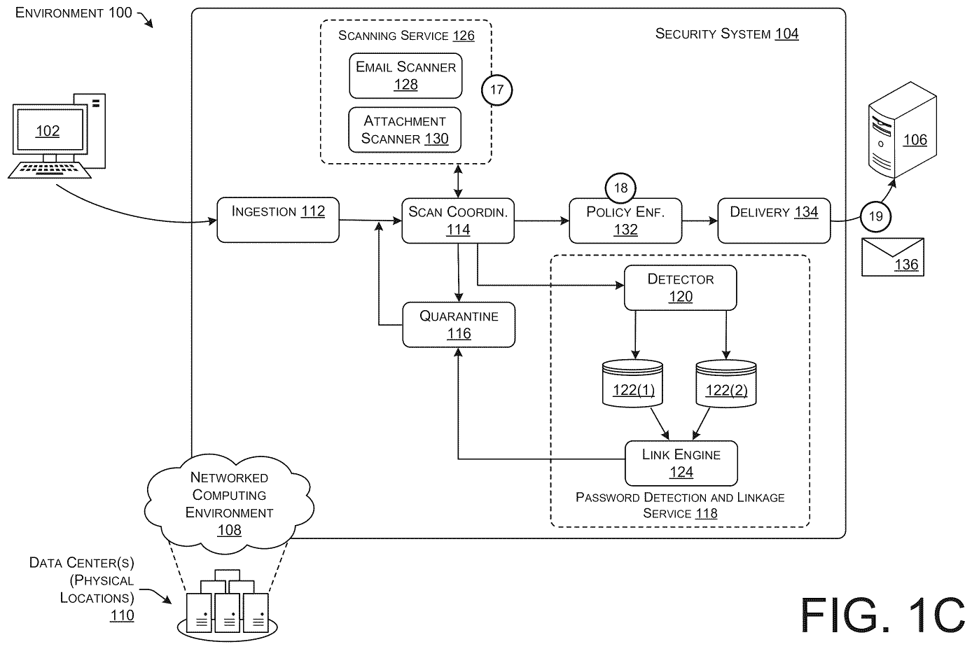

FIGS. 1A-1C collectively illustrate an example environment 100 in accordance with password linkage concepts. As shown in FIGS. 1A-1C, environment 100 may include a user device 102, a security system 104, and a computing device 106. The security system 104 may be viewed as a collection of services (e.g., applications, microservices) that are provided via a networked computing environment 108, which may be manifested as one or more data centers 110 (e.g., physical locations). The security system 104 may be associated with an organization, application, or other entity. In some examples, the security system 104 may operate as a cloud-based service. In other examples, the security system 104 may be provided via an on-premise network of one or more devices. The security system 104 may be in place at least in part to protect the organization or other entity from potential threats that may arrive in communications, such as email messages and/or attachments to email messages.

In some examples, the services provided by the security system 104 may include ingestion 112, scan coordinator 114, quarantine 116, and a password detection and linkage service 118, for instance. The password detection and linkage service 118 (designated by a dashed-line box) may include a detector 120, a database 122, and/or a link engine 124. The services provided by the security system 104 may also include a scanning service 126 (designated by a dashed-line box), which may include an email scanner 128 and/or an attachment scanner 130. Further, the services provided by the security system 104 may include policy enforcement 132 and delivery 134. The services of security system 104 will be described in greater detail through the example(s) provided below. The number of elements such as user device 102, the services and/or devices representing security system 104, and computing device 106 depicted in FIGS. 1A-1C is not meant to be limiting; any number of elements are contemplated in accordance with the present password linkage concepts. For instance, user device 102 may represent any number of external devices that may send communications to security system 104 and or the networked computing environment 108. Similarly, computing device 106 may represent any number of intended recipients of the communication(s) arriving at security system 104.

Any of the devices and/or services of environment 100 may be communicatively coupled to various other devices of environment 100 via network connection(s). For instance, networked computing environment 108 may represent a cloud network, which may feature a variety of devices (e.g., routers, servers, computing devices, controller devices, controllers) and other network devices. Within the example environment 100, any of the devices (e.g., user device 102, the devices of data center(s) 110, computing device 106, etc.) may exchange communications (e.g., packets) via network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” The use of a cloud computing network in this example is not meant to be limiting. Other types of networks are contemplated in accordance with password linkage concepts, such as an enterprise system. In some examples, the security system 104 and/or computing device 106 may be considered part of a local area network, or a software defined wide area network (SD-WAN). A variety of architectures are envisioned for the manifestation of password detection and linkage service 118. Security system 104 may include this service as an application or microservice running on one or more computing devices within the organization or within the same data center 110. In some examples, password detection and linkage service 118 may run as a separate cloud-based service, relatively independent from other physical devices of the security system 104. Scanning service 126 may similarly be implemented with a variety of network designs.

In general, example environment 100 may be used to illustrate a scenario in which an email 136 (e.g., communication, email communication, message) is received at the security system 104. The email 136 may have been sent from user device 102. The email 136 may be intended for delivery to a user and/or organization. The sending user device 102 may be external to the organization, such that the user device 102 may be referred to as an external device. In the example shown in FIG. 1A, the email 136 may include a variety of features, such as a password-protected attachment 138 (PPA), content 140 (e.g., email body, text, images), and/or metadata 142. The scenario may include examples of communications between various devices and/or services of environment 100. In FIGS. 1A-1C, the communications are indicated with dashed, numbered lines. For example, referring to FIG. 1A, at “Step 1,” user device 102 may send email 136 to ingestion 112. Thus, the email 136 from the external device has arrived at a service (e.g., ingestion 112) of security system 104.

At “Step 2” of FIG. 1A, after receiving email 136, ingestion 112 may route the email 136 to scan coordinator 114. In some examples, this may be a routine process for incoming email to the organization. In other examples, routing the email 136 to the scan coordinator 114 may be triggered by recognizing that the email 136 in question has an attachment or link or other potential malicious material.

At “Step 3” of FIG. 1A, scan coordinator 114 may route the email 136 to scanning service 126 for scanning and/or analysis. For instance, email scanner 128 may determine that the email 136 has an attachment. Attachment scanner 130 may attempt to analyze the attachment. Without the associated or corresponding password, attachment scanner 130 may not be able to open the password-protected attachment 138. Email scanner 128 may or may not be enabled to determine that the attachment is a password-protected attachment 138 or determine whether the associated password is provided in the email 136, such as in the content 140 or metadata 142. In this example scenario, the relevant password is not available to the attachment scanner 130 at this point. A message may be delivered from the scanning service 126 to the scan coordinator 114 regarding the results of the scanning and/or analysis. For instance, an error code may be produced by the attachment scanner 130 indicating that the password-protected attachment 138 was not scanned. The message to the scan coordinator 114 may include the error code and simply indicate that scanning was incomplete. Stated another way, the scanning service 126 may not be “smart” enough to determine that the email 136 contains an attachment that is password-protected, it may simply fail to scan the attachment. Alternatively, the message received by the scan coordinator 114 from the scanning service 126 may provide more specific information, such as indicating that the password for the password-protected attachment 138 was not available as a reason that the scanning was not completed.

At “Step 4” of FIG. 1A, being unable to open and/or scan the email 136, scan coordinator 114 may take action to prevent a potential threat from reaching the organization, such as sending email 136 and/or password-protected attachment 138 to quarantine 116. Sending a communication to quarantine or delaying further delivery of a communication may be a routine procedure for any communication that is subject to analysis by scanning service 126 or that contains an attachment, for instance. In other examples, only particular communications designated by the scan coordinator 114 or another entity of the security system 104 may be subject to quarantine 116.

At “Step 5” of FIG. 1A, scan coordinator 114 may route password-protected attachment 138 to the password detection and linkage service 118. Password-protected attachment 138 may be sent to the password detection and linkage service 118 as a copy of the information sent to quarantine 116, in some examples. In some examples, the password detection and linkage service 118 may be allowed access to the password-protected attachment 138 and/or email 136 while in quarantine 116. The scan coordinator 114 may be provide password-protected attachment 138 and/or email 136 to the password detection and linkage service 118 for the purpose of trying to gain access to password-protected attachment 138.

At “Step 6” of FIG. 1A, detector 120 may receive password-protected attachment 138 and/or email 136 from scan coordinator 114 and/or have access to these elements. Detector 120 may analyze password-protected attachment 138 and/or email 136 to determine information that may ultimately be helpful in linking an appropriate password to password-protected attachment 138. For instance, detector 120 may use the error code produced by the attachment scanner 130 to detect the password-protected attachment 138. The error code may trigger detector 120 to check for the password-protected attachment 138. The error code may indicate to the detector 120 that the password-protected attachment 138 is encoded, or that the security system 104 has not been able to open the attachment. Detector 120 may perform its own analysis of password-protected attachment 138 and/or email 136. Thus, detector 120 may learn or determine that email 136 contains an attachment, that the attachment is password-protected, and/or that the associated password is currently unknown.

In some examples, detector 120 may filter the content 140 and/or the metadata 142 of the email 136 to gain further information. For instance, detector 120 may scan the content 140 (e.g., body of email 136, text of email 136) for look for patterns that suggest the presence of a password in a different email. Presence of phrases, such as “password will be sent,” “password was sent,” etc., may indicate that there is a password associated with the attachment. The scanning may be performed using a variety of methods and technologies, such as a learned language model (LLM) trained to detect emails that can contain password-protected attachments. Another example method for scanning is scanning for a string based on a regular expression pattern (e.g., Regex). In the example scenario depicted in FIG. 1A, detector 120 finds password-protected attachment 138. Note that in other examples, any of the scanning, detecting, or analyzing methods described above could be performed by the scanning service 126, for instance, for purposes of finding a password-protected attachment to send to the password detection and linkage service 118. Stated another way, the specific tasks or services performed by the elements of the security system 104 may be organized or ordered in a variety of ways in accordance with password linkage concepts.

At “Step 7” of FIG. 1A, detector 120 may forward password-protected attachment 138 to database 122(1) (e.g., password linkage database). Database 122(1) may represent of repository of information that may be helpful for linking password-protected attachments to matching passwords. Database 122(1) may store password-protected attachment 138 while the security system 104 is looking or waiting for the password. Database 122(1) may also store other associated information, such as content 140 or metadata 142, since this other information may eventually help with linking password-protected attachment 138 to a matching password. In some examples, database 122(1) may be referred to as an attachment database.

The example scenario of environment 100 continues with the communications depicted in FIG. 1B. Referring to FIG. 1B, at “Step 8,” user device 102 may send email 144 to ingestion 112. Note that in this instance, email 136 is still delayed in quarantine 116.

At “Step 9” of FIG. 1B, ingestion 112 may route email 144 to scan coordinator 114. At “Step 10” of FIG. 1B, scan coordinator 114 may route the email 144 to scanning service 126 for scanning and/or analysis. Email scanner 128 may determine that email 144 potentially contains a password. The scanning service 126 may produce a message regarding the potential password which may alert scan coordinator 114. At “Step 11” of FIG. 1B, scan coordinator 114 may route email 144 and/or information from email 144 to password detection and linkage service 118. In some examples, all incoming emails may be offered to detector 120 for analysis, rather than selecting emails that may potentially contain a password (or attachment). Similar to Step 5 of FIG. 1A, email 144 may be sent to the password detection and linkage service 118, a copy of email 144 may be sent, or the password detection and linkage service 118 may be allowed access to the email 144. In any case, password detection and linkage service 118 may be allowed to analyze information in email 144, such as content 146 and/or metadata 148. Note that since the scanning service 126 was able to examine email 144, this communication may not be prevented from continuing to the intended recipient. For instance, email 144 may not need to be held in quarantine 116 or otherwise delayed further.

At “Step 12” of FIG. 1BA, detector 120 may analyze email 144 to determine information that may be helpful in linking an appropriate password to password-protected attachment 138. For instance, detector 120 may use information produced by the scanning service 126 to detect a password 150 (represented as a key in FIG. 1B) from within content 146. Analysis of email 144 to try to detect a password may be performed using a variety of methods and technologies. In one example, pattern recognition may be used to scan the content 146 of email 144 for patterns that match common ways passwords are shared. For example, phrases like “your password is,” “the password for the attachment is,” or simply “password:” followed by a string of characters may indicate the presence of a password. In another example, natural language processing may be used to understand the context within the content 146 (e.g., email text) to recognize passwords even when they are communicated in more complex sentences or when the language varies. Regular expression (Regex) may be used to search the content 146 for patterns that resemble passwords, such as a combination of letters, numbers, and special characters. In yet another example, machine learning may be used. For instance, machine learning models that have been trained on a dataset of emails may be able to predict where passwords might be found within unstructured text. In the example scenario depicted in FIG. 1B, detector 120 finds password 150. Note that in some instances, any of the scanning, detecting, or analyzing methods described above could be performed by the scanning service 126 or another element of security system 104 for purposes of finding a password to send to the password detection and linkage service 118.

At “Step 13” of FIG. 1B, detector 120 may forward password 150 to database 122(2). Database 122(2) may be similar to database 122(1), representing of repository of information that may be helpful for linking password-protected attachments to matching passwords. In some examples, database 122(1) and database 122(2) may be viewed as a single repository containing both password-protected attachments and passwords and/or other information, such as a password linkage database. The password-protected attachments and passwords and/or other information may be arranged in tables and/or may be catalogued, indexed, mapped, and/or partitioned in a variety of ways. In some examples, database 122(2) may be referred to as a password database. Database 122(2) may also store additional information, such as content 146 or metadata 148, since this other information may eventually help with linking password-protected attachment 138 to a password, such as password 150.

At “Step 14” of FIG. 1B, link engine 124 may attempt to create a linkage (e.g., match) between password-protected attachment 138 and a matching password. In some examples, metadata 142 and metadata 148 may be used to help link password-protected attachment 138 to a password. For instance, to establish a correlation between an email containing a password and an email with a corresponding password-protected attachment, metadata elements may serve as reliable indicators of a potential linkage. Several email metadata elements that may be used as linkage indicators will now be described, including sender domain, recipient, conversation identifier (ID), subject line information, and contextual information.

A sender domain, or the domain portion of a sender's email address is often consistent across emails that include a password-protected attachment and corresponding password. Authentic communications regarding password-protected attachments usually originate from the same domain or sub-domain. The recipient email address for the user that received the password-protected attachment is expected to match the recipient who receives the password. This consistency should ensure that only the intended recipient has access to both the secured content and the means to unlock it. In another metadata example, companies usually include a same conversation ID (e.g., thread ID) in the header of both an email containing a password and the email with the corresponding password-protected attachment(s). The conversation ID may help an email client group keep related emails in a single thread or conversation view, for instance. In some cases, the subject lines of both emails may share similar keywords, reference numbers, or phrases that tie them together. For example, both subject lines might include a reference to a “quarterly report,” “account statement,” or a specific transaction or case number. Finally, contextual information within the email body may be helpful. The body of both emails might contain overlapping content that indicates they are related. For instance, both emails may discuss the same topic, such as a bank statement, a contract, or an invoice, which may suggest a connection between the two emails. In another instance, the name of the company or institution sending the emails is typically present in both the emails. The consistent mention of the company name may reinforce the link between the emails. The signature block, including the sender's contact information and professional title, is usually similar, if not identical in both emails. This includes any legal disclaimers, branding, or logos that accompany the sender's signature. Examples of potentially useful contextual information may further include brand information in the email body, header information (e.g., brand information, BIMI, message-ID), and/or any of a variety of other information, such as an originating server, hostnames, internet protocol (IP) addresses, etc.

In some implementations, the password linkage concepts described above may be viewed as part of a linkage algorithm for detecting and linking a password-protected attachment and password. The linkage algorithm may be performed by one or more elements of the security system 104 depicted in FIGS. 1A-1C. For instance, steps of the linkage algorithm may be performed by elements of the password detection and linkage service 118. In some examples, some of the steps may be performed by the scanning service 126 and/or results from analysis performed by the scanning service 126 may be used by the password detection and linkage service 118. Steps of an example linkage algorithm will now be described for the purpose of further detailing the password linkage concepts described above. Some aspects of the example linkage algorithm described below may be similar to aspects of the examples described above relative to FIGS. 1A and 1B. Therefore, for sake of brevity, not all elements of the example linkage algorithm will be described in detail.

One step of an example linkage algorithm may include identification of password-protected attachments in communications. For example, when a security system (e.g., Secure Email Gateway (SEG)), such as security system 104, receives an email with a password-protected attachment, the security system may attempt to detect password-protected attachments. In another step of the linkage algorithm, the security system may store email and attachment information in an attachment database, such as database 122(1) depicted in FIGS. 1A-1C. The attachment database may be able to keep track of attachments that are pending password entry. Additionally, metadata stored in the attachment database may include all or part of data collected using techniques described above involving the analysis of email content/metadata. Later, the metadata may be used to match an attachment with a corresponding password.

Continuing with the linkage algorithm, when the security system receives an email that may contain a password, the security system may try to detect the password using the scanning techniques described above. When the security system is able to identify a password, the password and related metadata may be stored in a password database, such as password database 122(2) depicted in FIGS. 1A-1C. The metadata stored in association with the password may include all or part of data collected using the scanning techniques described above, the metadata may be later used to match an attachment with a corresponding password.

Next the linkage algorithm may use a link engine, such as link engine 124 shown in FIGS. 1A-1C. In some examples, the link engine may be viewed as operating in the background of a security system. The link engine may wait, or be dormant, until being triggered to take action. In the example linkage algorithm, a trigger for the link engine may be a new entry being added either to the attachment database or to the password database. Upon detection of a new password or attachment, the link engine may begin the process of correlating the metadata in the attachment database and the password database to determine whether a successful combination of password and attachment may be found. Note that with the detection logic described herein, the linkage algorithm may perform successfully regardless of whether the security system received the password first or the attachment first. In either order, the information will be stored in the appropriate database, and arrival of new information will trigger the link engine to investigate whether a match may be found.

As part of the linkage algorithm, the link engine may perform selection of a password and attachment for an attempt to confirm a match. The selection may be informed by analysis of the metadata stored in the attachment database and the password database. The analysis may include assigning weights to various pieces or combinations of metadata. The weighting may be determined by how much a particular type of metadata is known to indicate a match between an attachment and a password. For instance, some categories (e.g., types) of metadata are more likely to indicate a match. In some examples, different categories of metadata may be viewed as being in a primary level (e.g., upper level, first tier, etc.) of metadata and are more likely to indicate a match. Accordingly, other categories of metadata may be viewed as being in a secondary level (e.g., lower level, second tier, etc.) of metadata that are a weaker indication of a match than the primary level elements. For instance, matching in a category such as sender domain, recipient, conversation ID, or subject line information may be considered a stronger indication of a match than matching in a category such as contextual information found in the email body. Therefore, a weight for matching metadata of the emails that were associated with the attachment and the password, where the metadata include matching primary level information, may have a higher value than another weight for matching metadata that include secondary level information. For instance, matching a sender domain may carry higher weight than matching brand information. Note that the weight(s) may be assigned to the metadata before storage in the password linkage database. The weights may be stored in association with the attachment and/or password. In other examples, the weight(s) may be assigned after the link engine is triggered to find a potential match.

Once the security system has assigned one or more weights to the metadata and/or potential metadata pair combinations, a match score for a potential password and attachment pair may be generated using the weight(s). For instance, a potential password and attachment pair may be assigned a higher match score where weights are included for multiple metadata pair combinations (e.g., both the sender domain and the conversation ID of the emails match), indicating a higher likelihood of a match between the password and attachment. In some examples, when the match score is above a predefined threshold, the link engine may determine that the password and attachment should be selected for an attempt at decoding. Stated another way, the link engine may create the linkage between the password and attachment based on a sufficiently high match score.

The linkage algorithm may then proceed with using the password to attempt to unlock (e.g., decode) the attachment. In some examples, the link engine may test the password to confirm whether it is a match, may use the password to attempt to decode the attachment, or may forward the selected password and attachment pair to another component of the security system to confirm the match and/or unlock the attachment using the password. Note that if successfully unlocked, the contents of the unlocked attachment are still expected to be checked by the security system before the email is released to the intended recipient.

At this point, the example scenario of environment 100 may continue in FIG. 1B with “Step 15,” which may represent a variety of options for proceeding to check the contents of the attachment. In some examples, link engine 124 may indicate to quarantine 116 that email 136 may be released. In other examples, link engine 124 may forward the now unlocked password-protected attachment 138 and/or the matching password 150 to quarantine 116 or to some other component of security system 104, such as scan coordinator 114 or scanning service 126. In yet another example, link engine 124 may indicate in a message to scan coordinator 114 that email 136 may be released from quarantine 116 and/or that password 150 is a match for password-protected attachment 138. At “Step 16,” email 136 may exit quarantine 116 and return to the scan coordinator 114 for further processing. In yet other examples, email 136 may remain in quarantine 116 while the password-protected attachment 138 is sent to the scanning service 126 for threat detection.

In some implementations, referring again to Step 14, link engine 124 may select a potential matching password and attachment, but may not attempt to confirm the match, as suggested above. In this example, Step 15 may represent link engine 124 simply sending a message to quarantine 116 (or to scan coordinator 114) that a potential match has been found. The message may contain the potentially matching password 150. Subsequently, another element of security system 104 may attempt to use password 150 with password-protected attachment 138. For instance, quarantine 116 or scanning service 126 may be enabled to determine whether the match is correct. Referring again to Step 14, in a scenario where link engine determines that a password and attachment do not match, such as if the password fails to unlock, decode, or open the attachment, the password, attachment, and any associated metadata may simply remain in the respective database(s) until a new potential match is found. Alternatively, if the potential match is found to be invalid or unsuccessful by an element outside the password detection and linkage service 118, such as if the scanning service 126 tries to analyze an attachment with a potentially matching password and fails, the attachment and/or password may simply loop back to the password detection and linkage service 118. In this instance the attachment and/or password may return to the database(s) to await selection with a new potential matching pair.

The example scenario of environment 100 continues with the communications depicted in FIG. 1C. Referring to FIG. 1C, at “Step 17,” scan coordinator may direct email 136, password-protected attachment 138, and/or password 150 back to scanning service 126. The now unlocked, decoded, and/or opened attachment may be examined to determine whether any threat exists. For instance, various threat and content scanners, such as email scanner 128 or attachment scanner 130, may be employed to determine whether a threat exists within the attachment. In the example scenario depicted in FIGS. 1A-1C, the scanning service 126 finds no threat in the (now unlocked) password-protected attachment 138, and the email 136 may have gained approval from this stage of the security system 104. The password-protected attachment 138 may now be viewed as an unlocked attachment (e.g., decoded attachment, opened attachment, etc.).

At “Step 18” of FIG. 1C, email 136 may continue on to other components of the security system 104. For instance, email 136 and/or (now unlocked) password-protected attachment 138 may be subject to review by policy enforcement 132. The email or attachment may be scrutinized against one or more policies of the organization to determine whether the communication may proceed. Note that policy enforcement 132 would not be able to complete the function of determining whether contents of password-protected attachment 138 were approved to proceed to the email recipient without the security system having successfully matched password 150 to password-protected attachment 138. Finally, delivery 134 may help email 136 arrive at computing device 106. In this example, computing device 106 may represent a mailbox of the intended recipient, such as a user or other entity within the organization.

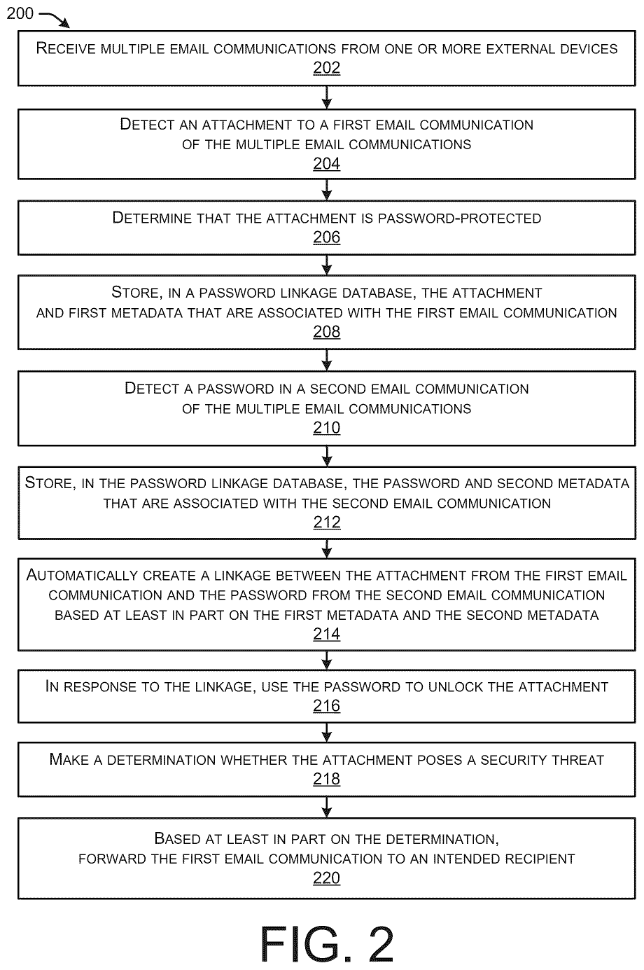

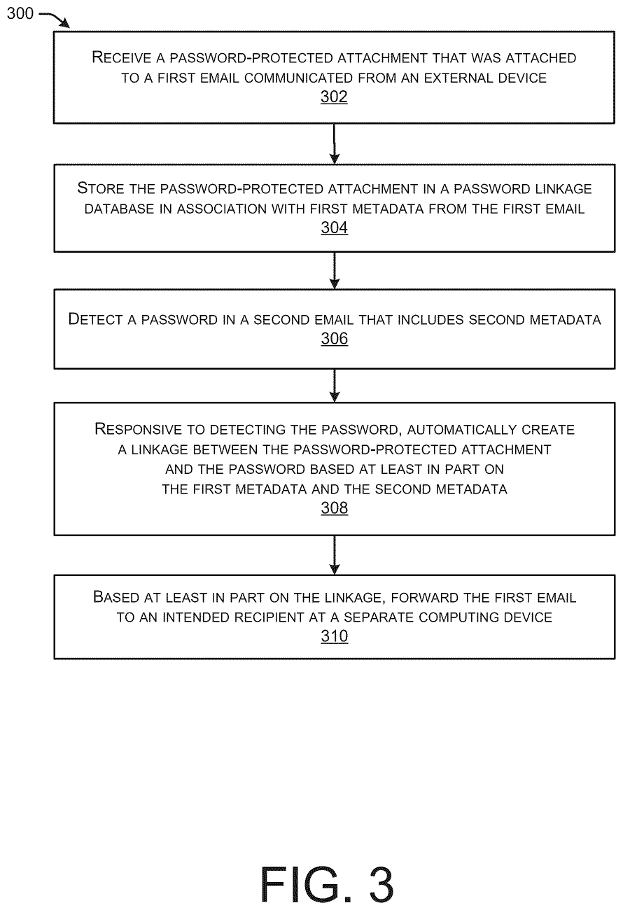

FIGS. 2 and 3 illustrate flow diagrams of example methods 200 and 300 that include functions that may be performed at least partly by security system or service, such as security system 104, described relative to FIGS. 1A-1C. The logical operations described herein with respect to FIGS. 2 and 3 may be implemented (1) as a sequence of computer-implemented acts or program modules running on a computing system and/or (2) as interconnected machine logic circuits or circuit modules within the computing system. In some examples, the method(s) 200 and/or 300 may be performed by a system comprising one or more processors and one or more non-transitory computer-readable media storing computer-executable instructions that, when executed by the one or more processors, cause the one or more processors to perform the method(s) 200 or 300.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 2 and 3 and described herein. These operations may also be performed in parallel, or in a different order than those described herein. Some or all of these operations may also be performed by components other than those specifically identified. Although the techniques described in this disclosure is with reference to specific devices and/or services, in other examples, the techniques may be implemented by less devices, more devices, different devices, or any configuration of devices and/or components.

FIG. 2 illustrates a flow diagram of an example method 200 for network devices to password linkage techniques. Method 200 may be performed by a security system (e.g., security system 104) communicatively coupled to at least one external user device (e.g., user device 102) and one or more computing devices (e.g., computing device 106), for instance.

At 202, method 200 may include receiving multiple email communications from one or more external devices.

At 204, method 200 may include detecting an attachment to a first email communication of the multiple email communications.

At 206, method 200 may include determining that the attachment is password-protected.

At 208, method 200 may include storing the attachment and first metadata that are associated with the first email communication. The attachment may be stored in a password linkage database, for instance. In some examples the first metadata may be associated with the attachment in the password linkage database.

At 210, method 200 may include detecting a password in a second email communication of the multiple email communications. The second email may be separate from the first email, both as a separate communication and also not consecutive communications, for instance. The first and second emails may be sent in either order with respect to which is received first at the security system. In some examples, detecting the password within a body of the second email communication may be accomplished using at least one of a pattern recognition, natural language processing, regular expression, or machine learning technology.

At 212, method 200 may include storing the password and second metadata that are associated with the second email communication. The password and second metadata may also be stored in the password linkage database. In some examples, the password and second metadata may be stored in a separate area of the password linkage database from the attachment.

At 214, method 200 may include automatically creating a linkage between the attachment from the first email communication and the password from the second email communication. In some examples, the linkage may be based at least in part on the first metadata and the second metadata. The creation of the linkage may be triggered by the storage of the password in the password linkage database. For instance, entry of the password into the password linkage database may cause the security system to initiate a scan of contents of the password linkage database to find potential matches between the newly deposited password and attachments that have been entered into the password linkage database.

In some implementations, method 200 may further include assigning one or more weights to the first metadata and the second metadata. The one or more weights may be based at least in part on a category (e.g., type) of the metadata. For instance, the category may be a sender domain, an intended recipient, or a conversation identifier of the first email communication and the second email communication. The one or more weights may be used to determine a match score. Automatically creating a linkage may in turn be based at least in part on the match score. In some examples, selecting the attachment and the password for the linkage may be based at least in part on the match score being above a predefined threshold.

At 216, method 200 may include using the password to unlock the attachment. Unlocking the attachment may be attempted in response to the linkage having been created. Based at least in part on determining that the attachment was password-protected, the first email communication may have been held in quarantine until the linkage was created. The first email communication may be released from quarantine in response to the linkage being created.

At 218, method 200 may include making a determination of whether the attachment poses a security threat. If the security system determines that the attachment poses a threat, the first email communication may be delayed indefinitely and/or disposed.

At 220, method 200 may include forwarding the first email communication to an intended recipient. Whether or not the security system chooses to forward the first email communication to the intended recipient may be based at least in part on the determination regarding whether the attachment poses a security threat.

FIG. 3 illustrates a flow diagram of an example method 300 for network devices to password linkage techniques. Method 300 may be performed by a security system (e.g., security system 104) communicatively coupled to at least one external user device (e.g., user device 102) and one or more computing devices (e.g., computing device 106), for instance.

At 302, method 300 may include receiving a password-protected attachment. The password-protected attachment may have been attached to a first email communicated from an external device. Method 300 may further include detecting the password-protected attachment in the first email.

At 304, method 300 may include storing the password-protected attachment in a password linkage database. Within the password linkage database, the password-protected attachment may be associated with or otherwise mapped to first metadata from the first email.

At 306, method 300 may include detecting a password in a second email. The second email may include second metadata. Responsive to detecting the password, method 300 may also include storing the password in the password linkage database.

At 308, method 300 may include automatically creating a linkage between the password-protected attachment and the password based at least in part on the first metadata and the second metadata. Automatically creating the linkage may be performed in response to detecting the password or to storing the password in the password linkage database. The linkage between the password-protected attachment and the password may be based at least in part on weighting of the first metadata and the second metadata. In some examples, the weighting may be related to a category or type of the first metadata and the second metadata.

At 310, method 300 may include forwarding the first email to an intended recipient at a separate computing device. Whether or not the security system chooses to release the first email to the intended recipient may be based at least in part on the linkage having been found.

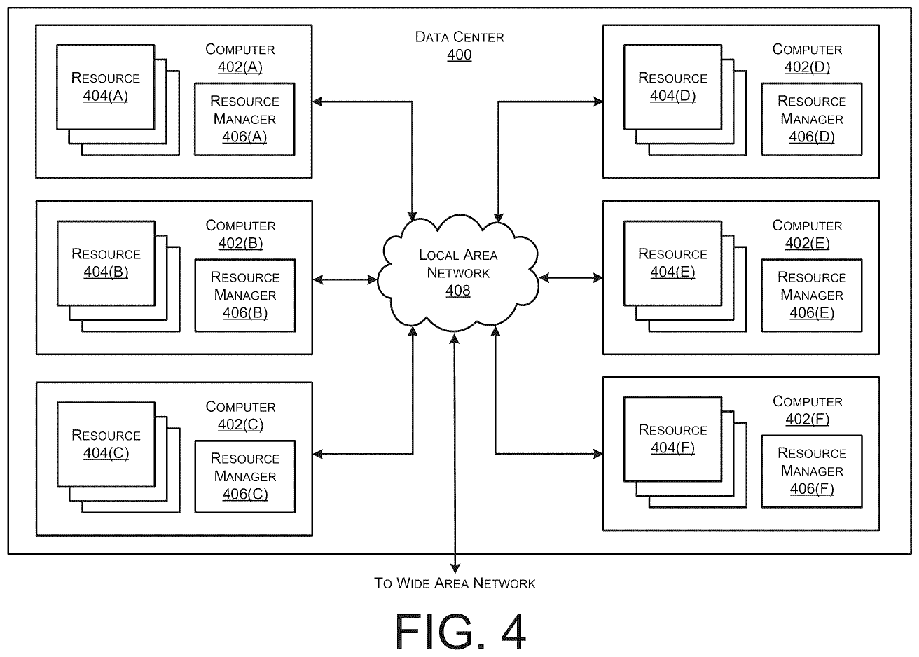

FIG. 4 is a computing system diagram illustrating a configuration for a data center 400 that can be utilized to implement aspects of the technologies disclosed herein. For instance, data center 400 may represent data center 110 described above relative to FIGS. 1A-1C. The example data center 400 shown in FIG. 4 includes several computers 402A-402F (which might be referred to herein singularly as “a computer 402” or in the plural as “the computers 402”) for providing computing resources. In some examples, the resources and/or computers 402 may include, or correspond to, any type of networked device described herein, such as user device 102, routers, mobile devices, and/or any of network devices 106. Although, computers 402 may comprise any type of networked device, such as servers, switches, routers, hubs, bridges, gateways, modems, repeaters, access points, hosts, etc.

The computers 402 can be standard tower, rack-mount, or blade server computers configured appropriately for providing computing resources. In some examples, the computers 402 may provide computing resources 404 including data processing resources such as virtual machine (VM) instances or hardware computing systems, database clusters, computing clusters, storage clusters, data storage resources, database resources, networking resources, and others. Some of the computers 402 can also be configured to execute a resource manager 406 capable of instantiating and/or managing the computing resources. In the case of VM instances, for example, the resource manager 406 can be a hypervisor or another type of program configured to enable the execution of multiple VM instances on a single computer 402. Computers 402 in the data center 400 can also be configured to provide network services and other types of services.

In the example data center 400 shown in FIG. 4, an appropriate local area network (LAN) 408 is also utilized to interconnect the computers 402A-402F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 400, between each of the computers 402A-402F in each data center 400, and, potentially, between computing resources in each of the computers 402. It should be appreciated that the configuration of the data center 400 described with reference to FIG. 4 is merely illustrative and that other implementations can be utilized.

In some examples, the computers 402 may each execute one or more application containers and/or virtual machines to perform techniques described herein. For instance, the containers and/or virtual machines may serve as server devices, user devices, and/or routers in the networked computing environment 108.

In some instances, the data center 400 may provide computing resources, like application containers, VM instances, and storage, on a permanent or an as-needed basis. Among other types of functionality, the computing resources provided by a cloud computing network may be utilized to implement the various services and techniques described above. The computing resources 404 provided by the cloud computing network can include various types of computing resources, such as data processing resources like application containers and VM instances, data storage resources, networking resources, data communication resources, network services, and the like.

Each type of computing resource 404 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 404 not mentioned specifically herein.

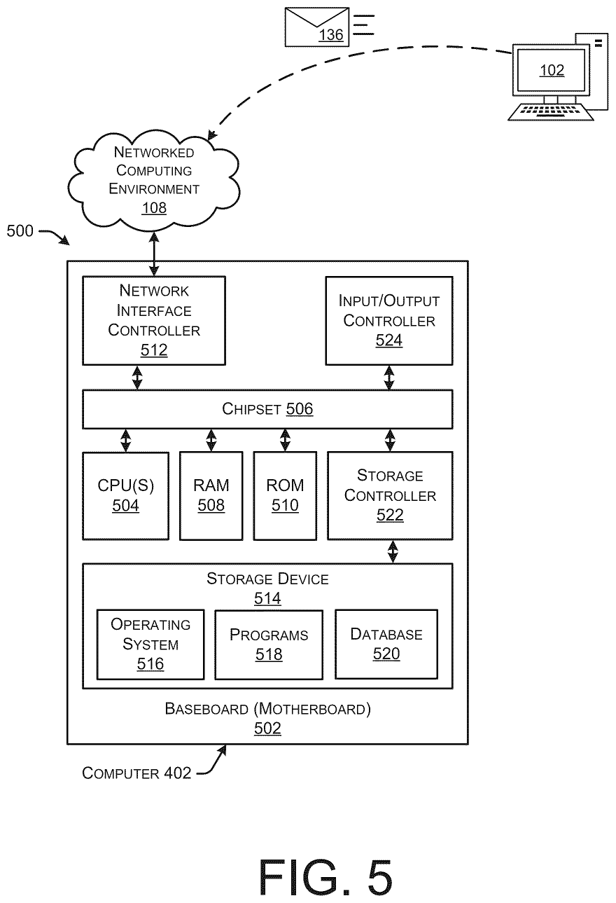

The computing resources 404 provided by a cloud computing network may be enabled in one embodiment by one or more data centers 400 (which might be referred to herein singularly as “a data center 400” or in the plural as “the data centers 400”). The data centers 400 are facilities utilized to house and operate computer systems and associated components. The data centers 400 typically include redundant and backup power, communications, cooling, and security systems. The data centers 400 can also be located in geographically disparate locations. One illustrative embodiment for a data center 400 that can be utilized to implement the technologies disclosed herein will be described below with regards to FIG. 5.

FIG. 5 shows an example computer architecture 500 for a computer 402 capable of executing program components for implementing the functionality described above. The computer architecture 500 shown in FIG. 5 illustrates a conventional server computer, workstation, desktop computer, laptop, tablet, network appliance, e-reader, smartphone, and/or other computing device, and can be utilized to execute any of the software components presented herein. The computer 402 may, in some examples, correspond to a physical device described herein (e.g., user device, computing device, device in a networked computing environment and/or data center, etc.), and may comprise networked devices such as servers, switches, routers, hubs, bridges, gateways, modems, repeaters, access points, etc. For instance, computer 402 may correspond to a device within data center 110.

As shown in FIG. 5, the computer 402 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 402.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 402. The chipset 506 can further provide an interface to a computer-readable storage medium such as a read-only memory (“ROM”) 510 or non-volatile RAM (“NVRAM”) for storing basic routines that help to start up the computer 402 and to transfer information between the various components and devices. The ROM 510 or NVRAM can also store other software components necessary for the operation of the computer 402 in accordance with the configurations described herein.

The computer 402 can operate in a networked environment using logical connections to remote computing devices and computer systems through a network, such as networked computing environment 108 or network 408, etc. The chipset 506 can include functionality for providing network connectivity through a network interface controller (NIC) 512, such as a gigabit Ethernet adapter. The NIC 512 is capable of connecting the computer 402 to other computing devices over the networked computing environment 108. For instance, in the example shown in FIG. 5, NIC 512 may help facilitate transfer of data, packets, and/or communications (indicated by email 136 in FIG. 5) over the networked computing environment 108 with computer 402. It should be appreciated that multiple NICs 512 can be present in the computer 402, connecting the computer to other types of networks and remote computer systems.

The computer 402 can be connected to a storage device 514 that provides non-volatile storage for the computer. The storage device 514 can store an operating system 516, programs 518, a database 520 (e.g., database(s) 122), and/or other data. The storage device 514 can be connected to the computer 402 through a storage controller 522 connected to the chipset 506, for example. The storage device 514 can consist of one or more physical storage units. The storage controller 522 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 402 can store data on the storage device 514 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 514 is characterized as primary or secondary storage, and the like.

For example, the computer 402 can store information to the storage device 514 by issuing instructions through the storage controller 522 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 402 can further read information from the storage device 514 by detecting the physical states or characteristics of one or more particular locations within the physical storage units.

In addition to the mass storage device 514 described above, the computer 402 can have access to other computer-readable storage media to store and retrieve information, such as policies, program modules, data structures, and/or other data. It should be appreciated by those skilled in the art that computer-readable storage media is any available media that provides for the non-transitory storage of data and that can be accessed by the computer 402. In some examples, the operations performed by the networked computing environment 108, and/or any components included therein, may be supported by one or more devices similar to computer 402. Stated otherwise, some or all of the operations performed by the networked computing environment 108, and or any components included therein, may be performed by one or more computer devices 402 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 514 can store an operating system 516 utilized to control the operation of the computer 402. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 514 can store other system or application programs and data utilized by the computer 402.

In one embodiment, the storage device 514 or other computer-readable storage media is encoded with computer-executable instructions which, when loaded into the computer 402, transform the computer from a general-purpose computing system into a special-purpose computer capable of implementing the embodiments described herein. These computer-executable instructions transform the computer 402 by specifying how the CPUs 504 transition between states, as described above. According to one embodiment, the computer 402 has access to computer-readable storage media storing computer-executable instructions which, when executed by the computer 402, perform the various processes described above with regards to FIGS. 1A-3. The computer 402 can also include computer-readable storage media having instructions stored thereupon for performing any of the other computer-implemented operations described herein.

The computer 402 can also include one or more input/output controllers 524 for receiving and processing input from a number of input devices, such as a keyboard, a mouse, a touchpad, a touch screen, an electronic stylus, or other type of input device. Similarly, an input/output controller 524 can provide output to a display, such as a computer monitor, a flat-panel display, a digital projector, a printer, or other type of output device. It will be appreciated that the computer 402 might not include all of the components shown in FIG. 5, can include other components that are not explicitly shown in FIG. 5, or might utilize an architecture completely different than that shown in FIG. 5.

As described herein, the computer 402 may comprise one or more devices, such as a user device 102, computing device 106, any device of networked computing environment 108 and/or data center(s) 110, and/or other devices. The computer 402 may include one or more hardware processors 504 (processors) configured to execute one or more stored instructions. The processor(s) 504 may comprise one or more cores. Further, the computer 402 may include one or more network interfaces configured to provide communications between the computer 402 and other devices, such as the communications described herein as being performed by a user device 102, computing device 106, any device of networked computing environment 108 and/or data center(s) 110, and/or other devices. In some examples, the communications may include email, attachment, messages data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 518 may comprise any type of programs or processes to perform the techniques described in this disclosure in accordance with password linkage techniques. For instance, the programs 518 may cause the computer 402 to perform techniques for communicating with other devices using any type of protocol or standard usable for determining connectivity. Additionally, the programs 518 may comprise instructions that cause the computer 402 to perform the specific techniques for password linkage.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving multiple email communications from one or more external devices;
detecting an attachment to a first email communication of the multiple email communications;
determining that the attachment is password-protected;
storing, in a password linkage database, the attachment and first metadata that are associated with the first email communication;
detecting a password in a second email communication of the multiple email communications;
storing, in the password linkage database, the password and second metadata that are associated with the second email communication;
automatically creating a linkage between the attachment from the first email communication and the password from the second email communication based at least in part on the first metadata and the second metadata;
in response to the linkage, using the password to unlock the attachment;
making a determination whether the attachment poses a security threat; and
based at least in part on the determination, forwarding the first email communication to an intended recipient.

2. The computer-implemented method of claim 1, wherein the storing the password in the password linkage database triggers the automatically creating the linkage.

3. The computer-implemented method of claim 1, further comprising:
assigning one or more weights to the first metadata and the second metadata; and
determining a match score based at least in part on the one or more weights, wherein the automatically creating a linkage is based at least in part on the match score.

4. The computer-implemented method of claim 3, wherein the automatically creating the linkage further comprises:
selecting the attachment and the password for the linkage based at least in part on the match score being above a predefined threshold.

5. The computer-implemented method of claim 3, wherein the one or more weights are based at least in part on a category of the first metadata and the second metadata.

6. The computer-implemented method of claim 5, wherein the category comprises at least one of:
a sender domain of the first email communication and the second email communication;
the intended recipient of the first email communication and the second email communication; or
a conversation identifier of the first email communication and the second email communication.

7. The computer-implemented method of claim 1, wherein the detecting the password further comprises:
detecting the password within a body of the second email communication using at least one of:
pattern recognition;
natural language processing;
regular expression; or
machine learning.

8. The computer-implemented method of claim 1, wherein the first email communication is held in quarantine based at least in part on determining that the attachment is password-protected, and wherein the method further comprises:
releasing the first email communication from the quarantine in response to the linkage being created.

9. A security system comprising:
one or more processors; and
one or more non-transitory computer-readable media storing computer-executable instructions that, when executed by the one or more processors, cause the one or more processors to:
receive multiple email communications from one or more external devices;
detect an attachment to a first email communication of the multiple email communications;
determine that the attachment is password-protected;
store, in a password linkage database, the attachment and first metadata that are associated with the first email communication;
detect a password in a second email communication of the multiple email communications;
store, in the password linkage database, the password and second metadata that are associated with the second email communication;
automatically create a linkage between the attachment from the first email communication and the password from the second email communication based at least in part on the first metadata and the second metadata;
in response to the linkage, use the password to unlock the attachment;
make a determination whether the attachment poses a security threat; and
based at least in part on the determination, forward the first email communication to an intended recipient.

10. The security system of claim 9, wherein the storing the password in the password linkage database triggers the automatically creating the linkage.

11. The security system of claim 9, wherein the computer-executable instructions further cause the one or more processors to:
assign one or more weights to the first metadata and the second metadata; and
determine a match score based at least in part on the one or more weights, wherein the automatically creating a linkage is based at least in part on the match score.

12. The security system of claim 11, wherein the computer-executable instructions further cause the one or more processors to:
select the attachment and the password for the linkage based at least in part on the match score being above a predefined threshold.

13. The security system of claim 11, wherein the one or more weights are based at least in part on a category of the first metadata and the second metadata.

14. The security system of claim 13, wherein the category comprises at least one of:
a sender domain of the first email communication and the second email communication;
the intended recipient of the first email communication and the second email communication; or
a conversation identifier of the first email communication and the second email communication.

15. The security system of claim 9, wherein the detecting the password further comprises:
detecting the password within a body of the second email communication using at least one of:
pattern recognition;
natural language processing;
regular expression; or
machine learning.

16. The security system of claim 9, wherein the first email communication is held in quarantine based at least in part on determining that the attachment is password-protected, and wherein the computer-executable instructions further cause the one or more processors to:
release the first email communication from the quarantine in response to the linkage being created.

17. A method comprising:
receiving a password-protected attachment that was attached to a first email communicated from an external device;
storing the password-protected attachment in a password linkage database in association with first metadata from the first email;
detecting a password in a second email that includes second metadata;
responsive to detecting the password, automatically creating a linkage between the password-protected attachment and the password based at least in part on the first metadata and the second metadata; and
based at least in part on the linkage, forwarding the first email to an intended recipient at a separate computing device.

18. The method of claim 17, further comprising:
detecting the password-protected attachment in the first email.

19. The method of claim 18, further comprising:
responsive to detecting the password, storing the password in the password linkage database,
wherein automatically creating the linkage between the password-protected attachment and the password based at least in part on the password being stored in the password linkage database.

20. The method of claim 19, wherein the linkage between the password-protected attachment and the password is based at least in part on weighting of the first metadata and the second metadata, the weighting related to a category of the first metadata and the second metadata.
